(19) United States
(12) Patent Application Publication
(10) Pub. No.: US 2008/0015975 A1
(43) Pub. Date: Jan. 17, 2008

(54) Method and system for determining mobile emissions reduction credits

(76) Inventors: Andrew Ivchenko, Chandler, AZ (US); David W. Miller, Clarence Center, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/823,165

(22) Filed: Jun. 27, 2007

Related U.S. Application Data
(60) Provisional application No. 60/817,133, filed on Jun. 28, 2006.

(51) Int. Cl. G06Q 40/00; F02B 43/08

(52) U.S. Cl. 705/37; 123/3

(57) ABSTRACT

A method for providing a mobile emissions reduction credit or other tradable commodity (15) comprising the steps of identifying an emissions reduction technology for a pollutant (20), providing a portable emissions measurement system (PEMS) adapted to measure emissions of the pollutant (21), providing a mobile source (16), applying the emissions reduction technology to the mobile source to provide a modified mobile source (25), connecting the PEMS to the modified mobile source (26), taking measurements of the modified mobile source (28), analyzing the measurements to develop a modified emissions amount (29), determining a target emissions amount (19), determining the difference between the target emissions amount and the modified emissions amount (30), and converting the difference between the target emissions amount and the modified emissions amount into a tradable commodity (31). The step of determining a target emissions amount may comprise the steps of providing a PEMS adapted to measure emissions of the pollutant (21), connecting the PEMS to the mobile source (22), taking first measurements of the pollutant from the mobile source (23) and analyzing the measurements to develop a baseline emissions amount (24), or the target emissions amount may be a function of a regulation or standard (19).

### CROSS-REFERENCE TO RELATED APPLICATIONS

This application claims the benefit of U.S. Provisional Patent Application No. 60/817,133, filed Jun. 28, 2006. The entire content of such application is incorporated herein by reference.

### TECHNICAL FIELD

The present invention relates generally to the field of trading of emission reduction credits and, more particularly, to a method and system for determining and trading mobile emissions reduction credits.

### BACKGROUND ART

Government agencies worldwide have struggled with finding new and innovative approaches to address the growing problem of air pollution and global warming. Experts in the field have recognized the importance of developing market solutions to reduce greenhouse gas (GHG) emissions. Most proposed strategies to mitigate global climate change focus on reducing the release of carbon dioxide in the combustion of fossil fuels, the dominant source of GHG emissions to the atmosphere. Carbon dioxide emissions represent about 84 percent of total GHG emissions in the United States. In the United States, most carbon dioxide (98 percent) is emitted as a result of the combustion of fossil fuels. Consequently, carbon dioxide emissions and energy use are highly correlated. See Energy Information Administration, Emissions of Greenhouse Gases in the United States 2005, DOE/EIA-0573 (Washington, D.C. 2006).

The two main approaches that have been developed to address this problem include a command-and-control regulatory system and environmental credit trading. Under the command-and-control approach, environmental regulations require firms that emit pollutants to limit emissions to a set level or to install specific emission-reducing technologies. While fairly straightforward, this centralized approach can be costly both to industry and to society. Firms with high costs of pollution reduction and those with low costs are required to meet the same requirements, which may waste resources. Also, this approach often does not effectively recognize or encourage efficiency or clean technologies.

Environmental credit trading is a market based approach that allows regulated firms to meet their statutory obligations by purchasing pollution abatement services (credits) from lower-cost providers. Although the idea of using emissions trading as an instrument for climate policy is relatively new, there has been a marked growth of emission-trading plans worldwide. Thus, emissions trading is a government sanctioned approach used to facilitate pollution control by providing economic incentives for achieving reductions in the emissions of certain pollutants. Three broad types of emissions trading programs have emerged: reduction credit, averaging, and cap-and-trade programs. All three forms assume that an emissions control requirement has been put in place that requires emissions to be reduced to levels below what they otherwise would be. Cap-and-trade programs are the most popular, and represent the more significant departure from command-and-control regulatory systems. See generally, U.S. EPA, Clearing the Air: The Truth About Capping and Trading Emissions, EPA 430F-02-009 (May 2002). In such plans, a central authority, such as an air pollution control district or a government agency, sets limits or “caps” on certain pollutants. Companies or fleets of vehicles that intend to exceed these limits may buy emission reduction credits (ERCs) from entities that are able to remain below the designated limits. This transfer is usually referred to as a trade.

Many authorities believe that emissions trading is an effective strategy to reduce GHG emissions. See generally, Ellerman, Denny, Paul Joskow and David Harrison, Emissions Trading in the U.S.: Experience, Lessons, and Considerations for Greenhouse Gases, Pew Center on Global Climate Change, Arlington, Va. (May, 2003). The economic rationale for emissions trading is based on the assumption that for any given level of emissions reductions, total abatement costs will be smaller if emitters with the lowest incremental costs can be induced to take on a larger role in reducing emissions. Emissions trading creates the requisite incentives to bring about this outcome.

Emission trading is contemplated on an international level. The Kyoto Protocol is an agreement made under the United Nations Framework Convention on Climate Change (UNFCCC). The Kyoto Protocol binds ratifying nations to a similar system, with the UNFCCC setting caps for each nation. The primary reduction strategy under the Kyoto Protocol is a trading system that essentially makes carbon credits a commodity like oil or gas. Under Article 17 of the treaty, which came into effect on Feb. 16, 2005, nations that emit less than their quota of GHG emissions will be able to sell ERCs to polluting nations. Countries that ratify this protocol commit to reduce their emissions of carbon dioxide and five other GHGs, or engage in emissions trading if they maintain or increase emissions of these gases. The Kyoto Protocol dramatically expands upon the emissions trading mechanisms started in the United States. Most developed countries have ratified the Kyoto Protocol. In addition, the European Union Emission Trading Scheme is the largest multi-national emission trading system in the world. It establishes a cap-and-trade system to limit carbon dioxide emissions from large industrial sources. Operations commenced in January 2005 and all 25-member states of the European Union participate in the scheme.

The United States, which did not attempt to ratify the Kyoto Protocol, has the most experience with domestic emissions trading markets. The Clean Air Act (CAA) of 1970 is a federal law that requires the Environmental Protection Agency (EPA) to develop and enforce regulations to protect the general public from exposure to airborne contaminants that are known to be hazardous to human health. In 1976, EPA published an interpretive ruling pursuant to the CAA that allowed new source construction in areas that were not in attainment with National Ambient Air Quality Standards (NAAQS) only if a new source obtained emission reduction offsets that exceeded the emission increases from the new construction. A “source” can be either a stationary source, an area source, or a mobile source. “NAAQS” are maximum ambient concentrations of six designated pollutants that may endanger public health or welfare, and are established by the administrator of the EPA under Section 109 of the CAA. Most early types of emissions trading systems covered GHG emissions from stationary sources such as electric utilities and large industrial facilities.

The EPA designates all areas of the US as either attainment (where NAAQS are met) or non-attainment (where NAAQS are exceeded) areas for each of the six criteria pollutants. The CAA also mandates the EPA to develop regulations to bring non-attainment areas into compliance and to ensure that attainment areas remain in compliance. Each state is required to develop and implement a State Implementation Plan (SIP) to achieve attainment in non-attainment areas and prevent deterioration in attainment areas. The SIP must be consistent with EPA minimum requirements for the various categories of non-attainment and attainment areas in the state. Offsets are required in non-attainment areas for major new emission sources as part of the New Source Review (NSR) process. “Offsetting” means a new company can build, or an existing company can expand, emission producing activities only if it secures emission reduction credits (offsets) from another existing company with the end result being no net increase in emissions. “New Source Review” means the permitting requirements for major new and modified sources contained in parts C and D of Title I of the CAA and in 40 C.F.R. §§51.165, 51.166, and 52.21. These sources must implement Lowest Achievable Emissions Rate (LAER) technology, in which little weight is given to economics. Any remaining emission increases must be offset by purchasing from existing sources emission reduction credits at least equal to the expected increase. Large existing sources in non-attainment areas are often required to install Reasonably Available Control Technology (RACT) to help reduce overall emissions. These requirements identify the lowest emission limit that a source or source category is capable of meeting after considering technological and economic feasibility. In some areas, sources are allowed to meet RACT requirements by purchasing emission reduction credits or through other forms of trading.

The Clean Air Act Amendments of 1990 authorized the use of market-based approaches such as emission trading to assist states in attaining and maintaining the NAAQS for all criteria pollutants. See Clean Air Act Amendments of 1990, Pub. L. No. 101-549, 104 Stat. 2399 (codified as amended at 42 U.S.C. § 7401 et seq.). The EPA recognized that market-based approaches accomplish environmental goals at lower costs than traditional command and control regulation that establish specific, inflexible emissions limitations with which all affected sources must comply. The Acid Rain Program, a federal emissions trading program, is an example of an existing large-scale, market-based environmental program designed to achieve environmental and public health benefits through reductions in emissions of sulfur dioxide (SO₂) and nitrogen oxides (NOₓ), the primary causes of acid rain. Measuring emissions of criteria pollutants is a critical part of any emission-trading plan. Under the Acid Rain Program, affected utilities are required to install systems that continuously monitor emissions of SO₂, NOₓ, and other related pollutants in order to track progress, ensure compliance, and provide credibility to the trading component of the program.

Through a market-based allowance trading system, the utilities regulated under the Acid Rain Program, rather than a governing agency, decide the most cost-effective way to use available resources to comply with the acid rain requirements of the CAA. Utilities can reduce emissions by various means, including energy conservation measures, increasing reliance on renewable energy, reducing usage, employing pollution control technologies, switching to lower sulfur fuel, or developing other alternate strategies. Companies that reduce their emissions below the number of allowances they hold may trade allowances with other firms in their system, sell them to other utilities on the open market or through EPA auctions, or bank them to cover emissions in future years. Allowance trading provides incentives for energy conservation and technology innovation that can both lower the cost of compliance and yield pollution prevention benefits. See Environmental Law Institute, Emission Reduction Credit Trading Systems: An Overview of Recent Results and an Assessment of Best Practices, Environment Law Institute (October 2002).

EPA's subsequent interpretive rulings expressly allow owners of new sources to obtain emission credits from other companies that operate facilities located in the same air quality control region. To implement an emissions offset program, many states have developed regulations allowing sources to register their emissions reductions as ERCs that can be sold to companies required to offset emissions from new or modified sources. Brokerage companies typically handle sales between companies having surplus ERCs and those wanting to acquire such credits.

Federal mandates continue to support the growth of the emission credit industry in the United States. Executive Order 13149 of Apr. 21, 2000, Greening the Government Through Federal Fleet and Transportation Efficiency, mandated that the federal government exercise leadership in the reduction of petroleum consumption through the use of alternative fuel vehicles (AFVs) and alternative fuels. Under Sec. 401, Vehicle Reporting Credits, each agency acquisition of an alternative fuel light-duty vehicle counts as one credit towards fulfilling the AFV acquisition requirements of the Energy Policy Act of 1992. Agencies receive one additional credit for each light-duty AFV that exclusively uses an alternative fuel and for each Zero Emission Vehicle of any size. Agencies receive three credits for dedicated medium-duty AFVs and four credits for dedicated heavy-duty AFVs. Agencies can also receive one credit for every 450 gallons of pure bio-diesel used in diesel vehicles. The objective is to promote markets for more alternative fuel and fuel efficient vehicles, encourage new technologies, and reduce GHGs in the atmosphere.

Several states have also begun to enact emissions credit trading systems. On Feb. 26, 2007, the Governors of Arizona, California, New Mexico, Oregon and Washington announced the formation of the Western Regional Climate Action Initiative to implement a joint strategy to reduce GHG emissions. These states agreed to develop a regional target for reducing greenhouse gases, and devise a market-based cap and trade program to reach the target. The five states also agreed to participate in a multi-state registry to track and manage GHG emissions in their region. California Governor Arnold Schwarzenegger stated that this agreement sets the stage for a regional cap and trade program that will provide a framework for developing a national cap and trade program to address climate change. Emissions credit trading is now widely viewed as the central mechanism for any regulatory regime designed to reduce GHG emissions, whether that regime is the Kyoto Protocol, a replacement treaty, or a suite of more regionally based GHG regulatory systems.

All commonly accepted ERCs in the United States must meet each of five criteria before they can be certified by the relevant regulatory authority as an ERC. Namely, the emission reduction must be real, permanent over the period of credit generation, quantifiable, enforceable, and surplus to emission reductions that are already needed to comply with an existing requirement (local, state, or Federal) or air quality plan. See California Health and Safety Code (HSC) Section 39607.5 (March 2004), which requires the California Air Resources Board (CARB) to adopt an emissions trading methodology for use by local air pollution control air districts; State Regulation on Emissions Trading Methodology (HSC Section 39607.5), March 2004, at ftp://ftp.arb.ca.gov/carbis/reports/12071.pdf. These criteria are intended to ensure that the emission reduction is a permanent reduction from the emissions that would otherwise be allowed to offset the permanent increase in emissions from the new or expanding source.

Another type of emission credit is a Mobile Source Emission Reductions Credit (MERC). Under such programs, participants are allowed to purchase emission reduction credits generated within the transportation sector. The term “mobile sources” refers to motor vehicles, engines and equipment that moves, or can be moved, from place to place. Mobile sources include vehicles that operate on roads and highways (“on-road” or “highway” vehicles), as well as nonroad vehicles, engines, and equipment. Examples of mobile sources include passenger cars, light trucks, large trucks, buses, motorcycles, earth-moving equipment, nonroad recreational vehicles (such as dirt bikes and snowmobiles), farm and construction equipment, cranes, lawn and garden power tools, marine engines, ships, railroad locomotives and airplanes. In California, mobile sources account for about 60 percent of all ozone forming emissions and for over 90 percent of all carbon monoxide (CO) emissions from all sources. (“Mobile Source Emission Reduction Credits, Guidelines for the Generation of Mobile Source Emission Reduction Credits Through Purchase and Operation of New, Reduced-Emission Heavy-Duty Vehicles,” prepared by CARB Mobile Source Division, September 1995.) EPA has allowed mobile source emission reductions to be a source of tradable credits since 1986. However, the EPA's initial focus prior to the 1990 Clean Air Act amendments was on stationary source emissions to achieve NAAQS attainment. Furthermore, there was initially a lack of EPA guidance on quantifying mobile source emission reductions and translating those reductions into credits until 1993.

Given the relatively small reductions available from an individual vehicle and the time and expense involved in securing regulatory approval for MERC credits, creators and sellers of MERCs have been mostly fleet operators, especially heavy-duty diesel truck fleets, rather than individual vehicle owners. MERC credits are most often purchased by sources with a regulatory requirement to reduce or offset emissions. MERC provisions have been included in state rules for California, Colorado, Connecticut, Delaware, Louisiana, Maine, Massachusetts, Michigan, New Hampshire, New Jersey, New York, Oklahoma, and Texas. Available options to create MERCs include accelerated retirement (scrappage) programs, employee commute programs, vehicle repair, replacement, and retrofit programs, the conversion of fleets to alternative clean-fuel vehicles, the conversion or purchase of clean-fuel buses, loan guarantee programs, and jurisdictional based options designed to reduce vehicle congestion and fuel consumption.

Because mobile sources are the leading cause of urban air pollution, achieving additional emission reductions from mobile sources is both attractive and economically desirable. A study undertaken by California's South Coast Air Quality Management District in 1999 concluded that diesel emissions account for 71% of the estimated cancer incidence from urban air toxics—an estimated 16,250 cases of cancer in the Los Angeles area alone (“Diesel Soot Emerges as Leading Cancer Threat in Air Toxics Study,” Daily Environment Report, Nov. 8, 1999, p. A-8). However, the main objective of MERC programs has been to provide additional sources of credits for use by stationary sources to meet NSR offset and RACT requirements. MERCs can also be used in various jurisdictions by stationary sources for netting, bubbles, and penalties for non-compliance. To date, MERCs have typically represented a small fraction of the emission reduction credits created by stationary sources over the same period. Although there are numerous permissible options for generating MERCs, virtually all of the credits actually created have come from scrapping high-emitting vehicles and selling reformulated gasoline. The present invention is designed to remedy this shortcoming.

There are several accepted methods for quantifying stationary source emission reductions. However, the relatively limited creation of MERCs in jurisdictions where they are allowed is due to difficulties in quantification and the need to get approval for new quantification protocols. Procedures for calculating rather than directly measuring the reductions are still being developed. Calculations typically incorporate a set of assumptions and data derived from emission inventory models. The emission rates and annual mileage rates from these models are based on data from a number of individual vehicles and therefore represent the “average” vehicle. For example, an accelerated vehicle retirement program will likely attract vehicles which emit at levels both above and below the average emission level for any given model-year group. Similarly, replacement vehicles will also have a wide range of emissions both above and below the average. Therefore, for the purpose of calculating credits, it is necessary to use average emission rates and average annual mileage rates. Due to the lack of extensive data regarding in-use emissions, the uncertainties associated with some emission values are quite large. This greatly reduces the confidence that MERCs generated for pollutants also meet the “real and permanent” criteria for emission reduction credits.

A practical, cost-effective, and economically viable means of verifying that low emissions are maintained throughout the credit life of a MERC is needed to ensure that real emission reductions occur. Historically, heavy-duty vehicles have not been routinely tested for in-use emissions compliance since studies have shown that heavy-duty diesel engines are reasonably stable with respect to emissions deterioration over time. However, as reduced-emission engines that use alternative fuels and add-on control equipment, such as catalytic converters, are developed and put into use, emission deterioration rates may increase significantly. The implementation of an appropriate in-use testing program is necessary to ensure that the reduced emission levels associated with reduced-emission vehicles that participate in a credit program are maintained in customer use. The cooperation of the credit-generating vehicle operator and the credit user is expected in any effort deemed necessary to verify in-use compliance. At a minimum, it may be necessary for a certain number of vehicles to be made available for chassis dynamometer emission tests, along with the funds necessary to conduct such tests.

This approach has shortcomings. Chassis dynamometer emission tests using the Federal Test Procedure (FTP) for heavy-duty vehicles are expensive, and involve removing a fleet vehicle from service for a period of time. Moreover, the data derived from such tests is not representative of “real world” driving conditions. An alternative approach, outlined in the present invention, is using Portable Emissions Measurement Systems (PEMS) to create MERCs. Commercially available PEMS can test for NOₓ, HC, CO, CO₂, and particulate matter (PM), among others. Utilizing emissions data generated by a PEMS is a new concept only recently recognized by the EPA. See Final Rule on In-Use Testing Program for Heavy-Duty Diesel Engines and Vehicles, EPA420-F-05-021, June 2005. In 2005, EPA established a PEMS based, in-use testing program for heavy-duty diesel engines and vehicles. See In-Use Testing Program for Heavy-Duty Diesel Engines and Vehicles, EPA420-R-05-006, June 2005. EPA recognized the value of using PEMS for compliance testing, since such test devices can generate reliable test data from in-service engines operating over a broad range of typical transient conditions, and can measure all the gaseous pollutants required by the in-use testing program.

EPA recently established final rules for the testing of nonroad diesel engines, used primarily in construction, agricultural, and industrial applications. See Control of Emissions of Air Pollution From Nonroad Diesel Engines and Fuel, 69 Fed. Reg. 38,958 (Jun. 29, 2004) (to be codified at 40 C.F.R. pts. 9, 69, 80, 86, 89, 94, 1039, 1048, 1051, 1065 and 1068). The goal of this program will be to ensure that emissions standards are met throughout the useful life of the engines, under conditions normally experienced in-use. The EPA stated that a pilot program will be established to test these engines using PEMS, once the Agency and manufacturers gained the necessary experience with the in-use testing protocols and generation of in-use test data using PEMS devices in the heavy-duty diesel engines and vehicles in-use testing program referenced herein. Thus, a similar pilot program is expected to be part of any manufacturer-run, in-use NTE test program for nonroad engines. In addition, EPA has outlined PEMS standards in 40 CFR 1065, Engine Testing Procedures.

Although PEMS have been in use for several years, these are the first instances of EPA recognizing the value of such test devices, and relying on them as the centerpiece of important test and evaluation projects that lead to legal and regulatory decision making. This is a critical step that allows a device or strategy to be used by States in formulating their SIPS and related emission reduction strategies. The present invention recognizes a need created by this technical and regulatory milestone to develop a method to expand the availability of MERCs. The present invention allows for the practical, rapid creation of MERCs that meet the requirements of being real, permanent over the period of credit generation, quantifiable, enforceable, and surplus to emission reductions that are needed to comply with an existing requirement (local, state, or Federal) or air quality plan.

### DISCLOSURE OF THE INVENTION

With parenthetical reference to the corresponding parts, portions or surfaces of the disclosed embodiment, merely for the purposes of illustration and not by way of limitation, the present invention provides an improved method for providing a mobile emissions reduction credit or other tradable commodity (15) comprising the steps of identifying an emissions reduction technology for a pollutant (20), providing a mobile source (16), providing a portable emissions measurement system (PEMS) adapted to measure emissions of the pollutant (21), connecting the PEMS to the mobile source (22), take first measurements of the pollutant from the mobile source (23), analyzing the measurements to develop a baseline emissions amount (24), applying the emissions reduction technology to the mobile source to provide a modified mobile source (25), connecting the PEMS to the modified mobile source (26), taking second measurements of the modified mobile source (28), analyzing the second measurements to develop a modified emissions amount (29), quantifying the mobile emissions reduction produced by the emissions reduction technology (30) and converting the mobile emissions reduction into a tradable commodity (31).

The method may further comprise the step of marketing the tradable commodity and monetizing the tradable commodity (32). The tradable commodity may be a mobile emissions reduction credit (MERC) and the method may further comprise the steps of marketing and monetizing the MERC. The step of converting the mobile emissions reduction into a tradable commodity may comprise the step of converting the reduction or a portion of the reduction of emissions into at least one tradable credit, and the method may further comprise the step of marketing and monetizing the credit.

The step of converting the mobile emissions reduction into a tradable commodity may comprise the steps of receiving information to identify a customer account (33), assigning the mobile emissions reduction to the customer account (34), calculating a mobile emissions reduction credit (MERC) from the mobile emissions reduction (35) and crediting the MERC to the customer account (36). The method may further comprise the step of exchanging the MERC in the customer account for monetary assets (40-42) including debiting the MERC from the customer account (42). The method may comprise the step of receiving information to identify a second customer or purchaser (38), calculating an emissions amount of the pollutant for the purchaser (44), and assigning a liability value to the emissions amount for the purchaser (45), accepting payment from the purchaser (41), using the payment to purchase at least one MERC for the purchaser, and crediting the MERC as assets against the liability value assigned to the second customer for the emissions amount (42), whereby the emissions amount and the liability value in the second customer account is reduced accordingly.

The pollutant may be selected from a group consisting of nitrogen oxides (NOₓ), carbon monoxides (CO), carbon dioxides (CO₂), hydrocarbons (HC), sulfur oxides (SOₓ), particulate matter (PM) and volatile organic compounds (VOCs). The emissions reduction technology may be selected from a group consisting of alternative fuels, vehicle repairs, vehicle replacements, vehicle retrofits and hybrid engines. The mobile source may be selected from a group consisting of passenger cars, light trucks, large trucks, buses, motorcycles, off-road recreational vehicles, farm equipment, construction equipment, lawn and garden equipment, marine engines, aircraft, locomotives and water vessels.

The mobile source (66) may comprise an exhaust system (64) and the PEMS (60) may be connected to the mobile source by a temporary connection (62) to the exhaust system. The mobile source may comprise a combustion engine (63) and the PEMS may be connected (61) to the engine and adapted to sense operating parameters of the engine. The baseline emissions amount may be measured in units translatable into a commoditized weight and the units may be selected from a group consisting of grams per mile, grams per gallon and grams per brake-horsepower-hour. The method may further comprise the step of taking third measurements of the modified mobile source after taking the second measurements and analyzing the third measurements to verify the modified emissions amount (50). The method may further comprise the step of periodically monitoring the modified mobile source with the PEMS to determine if the emissions reduction technology is continuing to provide the modified emissions amount (50).

The method may further comprise the steps of providing a computer system (51), inputting the baseline emissions amount and the modified emissions amount into the computer system (52), processing the amounts to determine a number of mobile emissions reduction credits for the pollutant (31), and marketing the mobile emission reduction credits (32).

The invention also discloses a method of providing a mobile emissions reduction credit or other tradable commodity comprising the steps of identifying an emissions reduction technology for a pollutant (20), providing a portable emissions measurement system (PEMS) adapted to measure emissions of the pollutant (21), providing a mobile source (16), applying the emissions reduction technology to the mobile source to provide a modified mobile source (25), connecting the PEMS to the modified mobile source (26), taking measurements of the modified mobile source (28), analyzing the measurements to develop a modified emissions amount (29), determining a target emissions amount (19), determining the difference between the target emissions amount and the modified emissions amount (30), and converting the difference between the target emissions amount and the modified emissions amount into a tradable commodity (31). The step of determining a target emissions amount may comprise the steps (30b) of providing a portable emissions measurement system (PEMS) adapted to measure emissions of the pollutant (21), connecting the PEMS to the mobile source (22), taking first measurements of the pollutant from the mobile source (23) and analyzing the measurements to develop a baseline emissions amount (24), or the target emissions amount may be a function of a regulation or standard (19).

The invention also discloses a method for providing a mobile emissions reduction credit or other tradable commodity comprising the steps of identifying an emissions reduction technology for a pollutant (20), providing a portable emissions measurement system (PEMS) adapted to measure emissions of the pollutant (21), providing a mobile source (16), applying the emissions reduction technology to the mobile source to provide a modified mobile source (25), connecting the PEMS to the modified mobile source (26), taking measurements of the modified mobile source (28), analyzing the measurements to develop a modified emissions amount (29), determining a target emissions amount (19), determining the difference between the target emissions amount and the modified emissions amount (30), registering for a seller the emissions reduction technology or the pollutant (33), assigning the seller a mobile emissions reduction credit (MERC) that is a function of the difference in the emissions (34-35), making the MERC available for purchase (40), receiving a purchase request from a purchaser for the MERC, matching the seller and purchaser, and crediting the MERC to an account of the purchaser as an asset (42).

The step of making the MERC available for purchase may comprise pooling the MERC in a pool with other MERC values from a plurality of sellers having MERC values associated with the technology or the pollutant (40a). The method may further comprise the step of receiving a fee from the purchaser (41) and the fee may be obtained prior to crediting the MERC to the account of the purchaser. The method may further comprise the step of purchasing an amount of MERC from a seller sufficient to offset a liability value for the pollutant assigned to the purchaser (42a) and may further comprise the step of certifying the purchaser as being neutral as a result of the offset (42c).

The general object of the invention is to provide a globally recognized and accepted method for determining Mobile Emission Reduction Credits (MERCs) that can be recognized by the various central authorities such as EPA, California Air Resources Board (CARB), the Kyoto Protocol, and the European Union. Fast and accurate measurements with PEMS should make the approval process for MERCs more routine than currently available methods that only estimate emissions. Actual measurements address the current problem of whether a credit based on estimations meets three (“quantifiable, real and permanent”) of the five essential requirements of a MERC.

Another object is the joining together of aspects of both Kyoto-based mobile emission reduction credits as well as mobile emission reduction credits identified in US policy, and creating a standardized unit that can be used in both markets for mobile sources, assuming that eventually there will be one common unit traded on all common markets.

Another object is to provide a method for trading mobile source emission reduction credits.

Another object is to provide a mobile source emissions trading commodity.

Another object is to provide a method for converting an aggregate of mobile source emission reduction credits into a tradable commodity that can be marketed.

These and other objects and advantages will become apparent from the foregoing and ongoing written specification, the drawings, and the appended claims.

### BRIEF DESCRIPTION OF THE DRAWINGS

FIG. 1 is a schematic overview of an embodiment of the improved system.

FIG. 2 is a schematic of mechanical components and a testing configuration of an embodiment of the improved system.

FIG. 3 is a graph showing non-compliant, target or baseline and reduced emission levels of an embodiment of the improved system.

FIG. 4 is a schematic of the computer network for an embodiment of the improved system.

FIG. 5 is a block diagram of an embodiment of the improved system.

### DESCRIPTION OF THE PREFERRED EMBODIMENTS

At the outset, it should be clearly understood that like reference numerals are intended to identify the same structural elements, portions or surfaces, consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

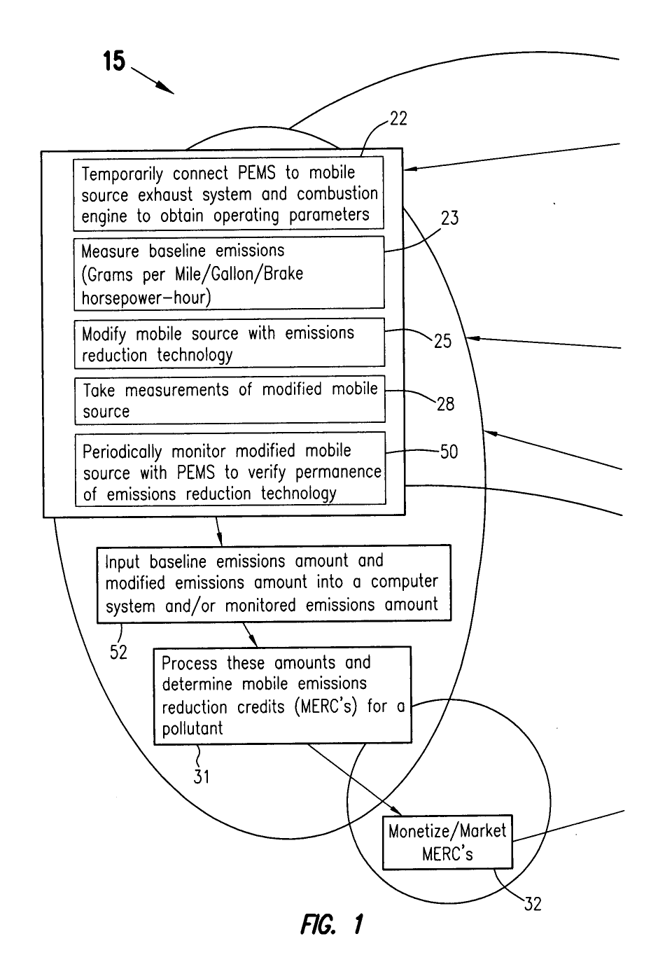

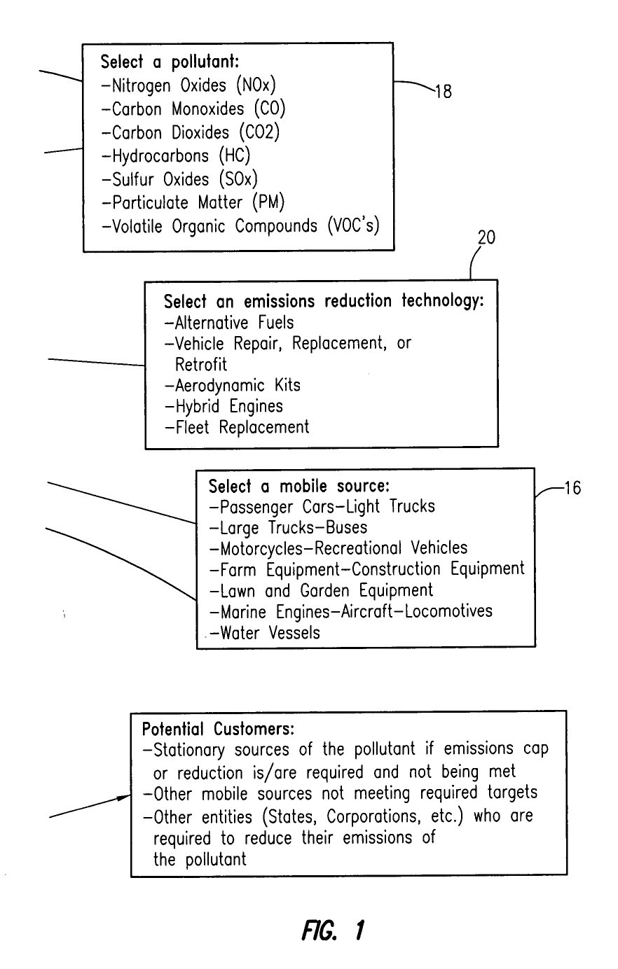

Referring now to the drawings and, more particularly, to FIG. 1 thereof, this invention provides a method for determining a Mobile Emission Reduction Credit or other tradable commodity, of which the presently preferred embodiment is generally indicated at 15. As shown in FIG. 1, the preferred embodiment generally includes three stages. The first stage includes the selection of a pollutant 18, the selection of an emissions reduction technology 20, and the selection of a mobile source 16. In the preferred embodiment, the pollutants selected are of particular concern for health or environmental reasons. They include nitrogen oxides (NOₓ), carbon monoxides (CO), carbon dioxides (CO₂), hydrocarbons (HC), sulfur oxides (SOₓ), particulate matter (PM) and volatile organic compounds (VOCs).

As part of this first stage, an emissions reduction technology related to the selected pollutant is also selected 20. Either the pollutant may be selected first and the emissions reduction technology selected to address the subject pollutant, or the emissions reduction technology may be selected and the pollutant identified or determined based on the efficacy of the emissions reduction technology. Numerous emissions reduction technologies presently available or hereafter developed may be used. For example, alternative fuels may be employed based on the fact that such fuels reduce emissions of a particular pollutant or pollutants. It is also known that a hybrid engine may be employed that reduces emissions from a vehicle. The vehicle or mobile source may be repaired or retrofit in such a way as to cause a reduction in pollutant(s) emissions. For example, a fleet of vehicles might be modified with a kit 65b that makes the vehicle more aerodynamic and therefor emit less pollutants. The vehicle or mobile source, or a fleet of vehicles or mobile sources, may be entirely replaced with new vehicles, thereby resulting in a reduction of emissions due to the new vehicle(s). These and other technologies may be identified, selected and employed in order to reduce emissions from the mobile source(s).

The first stage also involves selecting a mobile source 16. Again, the emissions reduction technology and pollutant(s) selected may be dependent on the mobile source selected, or vice versa. The term mobile source encompasses potential sources of pollutants that are not stationary. Examples of mobile sources are passenger cars, light trucks, large trucks, buses, motorcycles, recreational vehicles, farm equipment, construction equipment, lawn and garden equipment, marine engines, aircraft, locomotives and water vessels such as boats and ships.

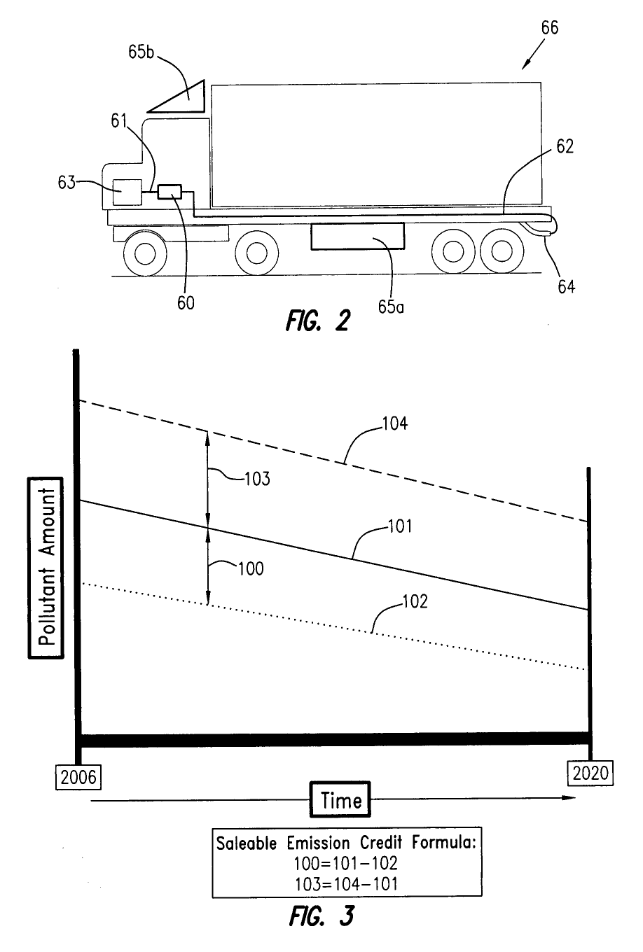

A single pollutant, a single emission reduction technology and a single mobile source, or multiple pollutants, multiple emission reduction technologies and multiple mobile sources, or any combination of the above, may be employed in the system. For example, as shown in FIG. 2, multiple emission reduction technologies may be used on a single vehicle to reduce emissions of one or more pollutants of interest.

The second stage of the system involves determining the reduction, if any, in emissions of the pollutant from the mobile source due to the emissions reduction technology, the conversion of that reduction into a tradable commodity such as a Mobile Emission Reduction Credit (MERC), and the verification of that reduction. While it has been recognized that mobile sources such as cars and trucks are the leading cause of urban air pollution and that achieving emission reductions from mobile sources such as cars and trucks would be desirable, heretofore it has been difficult to quantify such reductions in mobile sources. In the prior art, emissions have been estimated based on a set of assumptions and data derived from emission inventory models. Unfortunately, this has greatly reduced the confidence that the MERCs generated for the pollutant meet the real and permanent criteria for many government sponsored emission reduction credits. Thus, such prior art estimates or calculations have not been generally accepted in trading systems. The inventive system disclosed in this application addresses this problem by employing a portable emissions measurement system (PEMS) in the calculation of mobile emissions reductions and the determination of the mobile emission reduction credit to be traded. A PEMS is an onboard testing system or device that measures the emissions from the mobile source while the source is in actual, real-world use, rather than in a laboratory or simulated environment. The system is connected to the mobile source so as to measure the emissions of the selected pollutant(s) when the source is in regular use. While such systems are known in the prior art, no one has developed a system for determining a tradable commodity such as a MERC using a PEMS.

The MONTANA™ PEMS manufactured by Clean Air Technologies International, Inc., of 819 East Ferry Street, Buffalo, N.Y. 14211, may be used in the preferred embodiment. This system is capable of measuring second-by-second mass emissions on a variety of vehicle engines in actual, real world and regular use and operation. This PEMS is versatile, compact, lightweight, portable and easily installed. In the preferred embodiment, the unit provides HC, CO, CO₂, NOₓ and O₂ readings for gasoline powered vehicles and NOₓ, CO, CO₂, O₂ and PM (light scattering) readings for diesel vehicles. The pollutant concentrations are obtained from a sample probe inserted into the tail pipe. This data is then combined with exhaust flow data calculated using engine parameters read from the vehicles engine control unit to determine mass emissions.

U.S. Pat. No. 6,308,130, entitled “Portable On-Board Mass Emissions Measuring System,” discloses a PEMS for measuring mass emissions while a vehicle is in service. U.S. Pat. No. 6,435,019, entitled “Portable On-Board System for Measuring Vehicle Exhaust Particulate Emissions,” discloses a PEMS that measures emissions of particulate matter. The disclosure of each of U.S. Pat. No. 6,308,130 and U.S. Pat. No. 6,435,019 are incorporated in their entirety herein by reference.

It is contemplated that other PEMS units may be used depending on the selected pollutant(s). For example, the SPOT unit provided by Analytical Engineering, Inc., of 2555 Technology Boulevard, Columbus, Ind. 47201 may be used as an alternative. The SEMTECH® unit provided by Sensors, Inc., of 6812 S. State Road, Saline, Mich. 48176, may be used as another alternative. For particulate matter, the SCANNING MOBILITY PARTICLE SIZER™ manufactured by TSI, Inc., of 500 Cardigan Road, Shoreview, Minn. 55126 may be used as an alternative. A FTIR gas analyzer may also be utilized, such as the TITAN FTIR gas analysis system manufactured by MIDAC Corporation, 130 McCormick Avenue, Costa Mesa, Calif. 92626.

The PEMS is selected to take actual, on-board measurements of the subject pollutant(s) emitted by the subject mobile source when the mobile source is in real use. Using a PEMS, actual real world measurements are taken to determine the emissions of the pollutant(s) from the mobile source, including any emissions reduction from a baseline or target level.

As shown in FIG. 3, in the preferred embodiment, a MERC is provided as a function of any significant and measurable surplus emission reduction 100. Surplus emission reduction 100 is generally the difference between the emissions baseline or target level 101 and the reduced emissions level 102. Accordingly, the first step in the second stage of the preferred embodiment is to determine a baseline or target level 101. This is performed in a number of ways.

A target level 101 may be dictated by or derived from a government or regulatory body 19a. For example, a regulatory body may require that certain sized trucks or cars have emissions levels of certain pollutants at or below a given level. Based on this model, the target level 101 would be set by the regulatory body and any reduction below the target level 101 would be a surplus emission reduction SE for that pollutant. The target level 101 may also be determined based on the present day average emissions of the subject pollutant from the subject mobile source as evidenced by fleet records 19b. Industry standards may also be used to determine an average and target level 101 for the particular pollutant(s) and mobile source 19c.

In the preferred embodiment, the baseline or target 101 is determined using a PEMS 24. In this way, any reduction is an actual and non-simulated reduction for the particular mobile source and pollutant and is not an estimate. Thus, in the preferred embodiment, a PEMS capable of reading the selected pollutant and adapted to be used with the selected mobile source is provided 21 and connected to the mobile source 22. The PEMS is then used to measure the selected pollutant from the mobile source 23. These measurements are then analyzed to determine a quantifiable emissions baseline 24. Referring to the testing configuration shown in FIG. 2, in the preferred embodiment a PEMS 60 is temporarily connected to the exhaust system of mobile source 66 and with an engine computer link 61 to the mobile source's engine 63 control unit. In the preferred embodiment, pollutant concentrations are obtained from a sample line or probe 62 inserted into the tailpipe 64 of vehicle 66 and this data is then combined with readings from the engine 63 control unit to determine the emissions of the selected pollutant. Baseline emissions are measured and an emissions baseline level 101 is determined as a function of such measurements.

After taking first baseline measurements 23, mobile source 66 is modified with the emissions reduction technology 25. As shown in FIG. 2, multiple emission reduction technologies 65a-b are applied. In this embodiment, an exhaust filtering technology 65a and an aerodynamic technology 65b are applied to truck 66. Once the emission reduction technology has been applied, the PEMS is again connected to the vehicle 26 and used to take measurements of the modified mobile source 28. This PEMS data is then analyzed to develop a modified emissions amount or level 29.

The modified emissions level is then compared to the baseline emissions level 30. If the modified emissions level is significantly and measurably less than the baseline emissions level 101, then it may meet the criteria for a reduced emission level 102 in FIG. 3 and may provide as a surplus emissions reduction 100. This surplus emission reduction 100 is then converted 31 into a tradable commodity such as a MERC. In a preferred embodiment, surplus emissions reduction 100 is the difference between the baseline emissions level 101 determined from the PEMS data taken of the mobile source prior to its modification with the emissions reduction technologies. However, as indicated above, in alternative embodiments, the surplus emission reduction 100 may be determined as a function of an emissions target level 101 dictated by industry standard, fleet records or a regulatory or governmental body. In this case, the surplus emissions reduction 100 is the difference between reduced emissions level 102 and the subject target 19, rather than the calculated baseline 24.

If it is determined that a significant and measurable reduced emissions level 102, and thus a surplus emission reduction 100, has not been achieved with the emission reduction technology, the system allows for a number of options. First, different or additional emissions reduction technologies can be applied to the mobile source and steps 25-30 repeated. With these further modifications, the PEMS is again connected to the mobile source 26, additional measurements taken 28, such data analyzed to develop a modified emissions level 29, and the modified emissions level compared to the baseline to determine whether a significant and measurable surplus emission reduction has been achieved 30 with the new emission reduction technology or combination of emission reduction technologies. Alternatively, if required by a regulatory body and if the mobile source has emissions amounts that are greater than a target level 47, then the system allows for determining such a non-compliant emissions level 104 and a liability value 46 to the subject mobile source. This liability value may then be used later in step 45 to assign a liability value to a purchaser's or customer's account. Alternatively, the program is terminated 48 for that particular mobile source, pollutant or emission reduction technology.

If a reduced emissions level 102 is achieved, the differential surplus emissions 100 between the reduced level 102 and the baseline level 101 is converted into one or more MERCs 31. The conversion may include transferring the reduction into the applicable units of pollutant being traded and then determining the number of MERCs corresponding to the surplus emissions 100. These units and the ratio applied to convert the amount of the surplus emission reduction 100 into MERCs may depend upon the requirements of the overseeing regulatory body or authority for the program or the standards of the potential purchasers of the MERCs. Various units of measurements may be used, such as grams per mile, grams per gallon and grams per brake-horsepower-hour. It is contemplated that the MERCs may simply be the amount of reduction of the pollutant in the applicable units. Thus, the conversion from a surplus emissions reduction 100 to MERCs may be based on a one-to-one ratio.

This stage also includes verification steps 50. Periodically during the life of the mobile source, the PEMS is again connected to vehicle 26 and used to take measurements of the modified mobile source 28. This PEMS data is then analyzed to verify that the reduced emissions level 102 for the mobile source is still being achieved. If so, the credits are verified and continue. If not, the credits are modified to reflect the chance or are no longer provided, depending on the degree of change.

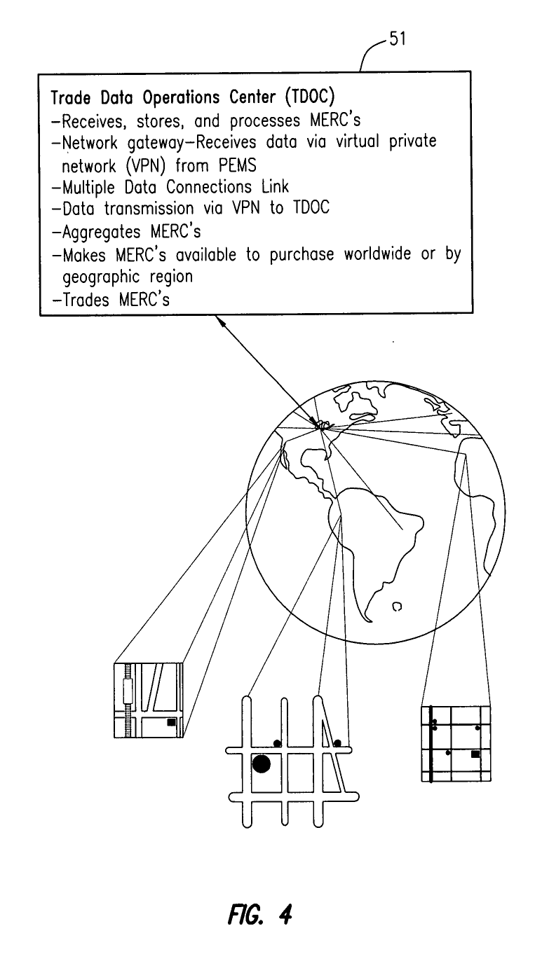

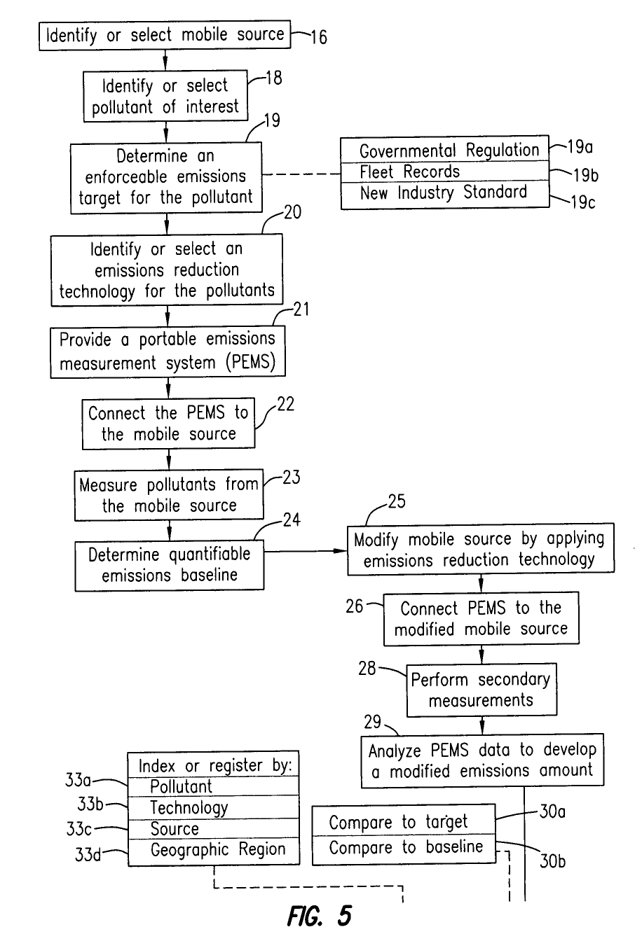

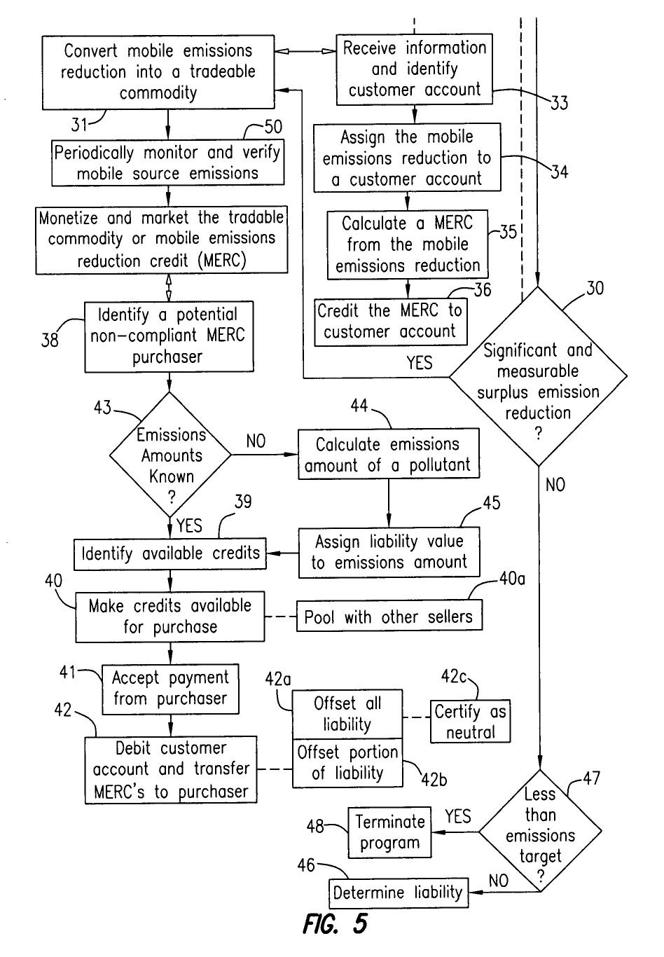

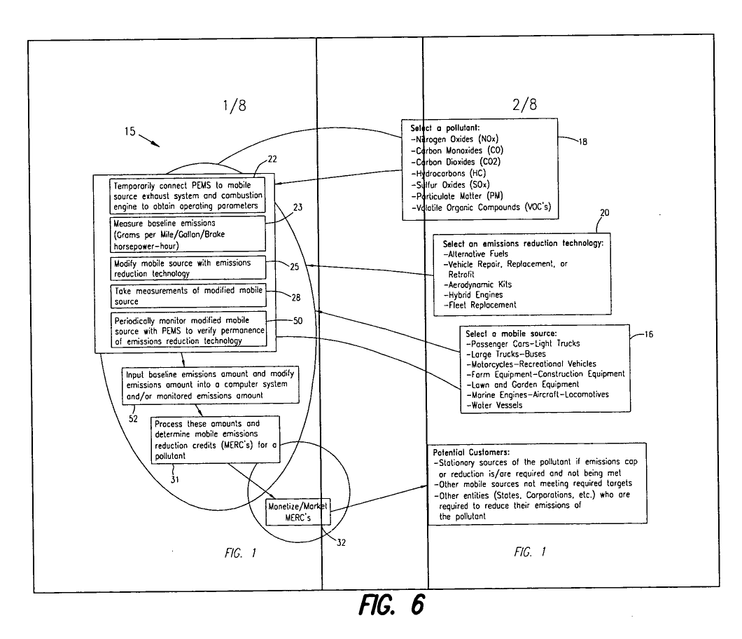

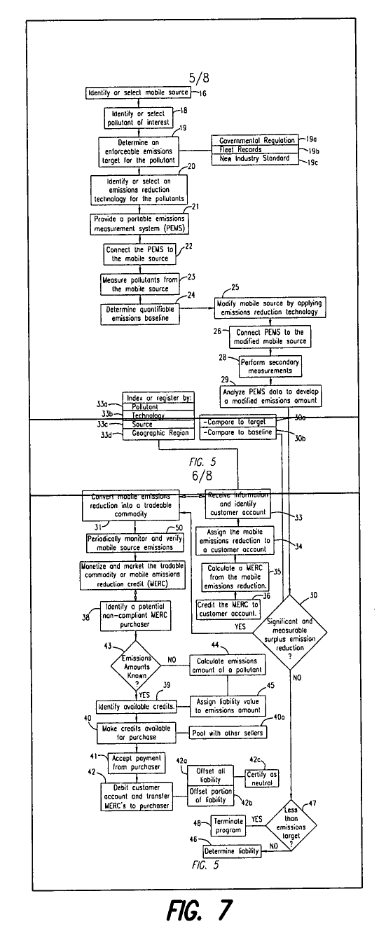

In the preferred embodiment, a computer system 51 is used to create or identifies a customer account and receives the data for that customer from the PEMS 33. The computer then performs the conversion of the surplus emissions reduction 100 into MERCs by calculating MERCs from the PEMS data and/or target level 35. The computer then credits the MERCs to the subject account 36. As shown in FIG. 4, data from PEMS on multiple mobile sources and from multiple different geographic locations may be received by the computer system and assigned to one or more customer accounts. The data and corresponding MERCs are indexed by pollutant 33a, emission reduction technology 33b, mobile source 33c and/or geographic area or region 33d. Computer system 51 is also used to collect verification data from PEMS and to analyze such data to monitor whether or not the emissions reduction technology is continuing to provide the modified emissions amount and reduced emissions level 102. Computer system 51 can also be provided with updated emissions target levels and can adjust the credits provided as a function of such new emission target levels.

By using a PEMS to determine the emissions reduction surplus and to periodically verify that surplus, the resulting MERCs are based on actually occurring, implemented, and not artificially devised, reductions in emissions, are accurately quantified in terms of amount and characteristics, are verifiable, are relatively permanent as they reflect the actual emissions of a permanently modified mobile source, and are in excess of any target emissions that may be required by rule, regulation or order.

Stage three involves the marketing and monetizing of the MERCs 32. A number of means of trading MERCs are known in the prior art and could be used at this stage. In the preferred embodiment, the MERCs are marketed and monetized by computer system 51. Potential purchasers of MERCs are identified 38. These purchasers are generally non-compliant producers of the subject pollutant(s). Such customers may include stationary sources of the pollutant if an emissions cap or reduction is required and is not being met by the stationary source. Potential customers could also be other mobile sources who are not meeting a required target with respect to emissions of the pollutant. Customers may also include other entities such as states and corporations who are required to reduce their emissions of the pollutant. As shown in FIG. 3, such purchasers generally have a non-compliant emissions level 104 for the pollutant(s) and therefore an emissions liability 103, which is the difference between their non-compliant emissions level 104 and the applicable emissions target level 101. If the emissions liability 103 is known, the system proceeds with offering to sell MERCs to the purchaser in an amount needed to off-set all 42a or a portion 42b of the purchaser's liability.

If the purchaser does not have a known liability, but is required to determine if it is non-compliant, and such potential purchaser has mobile sources, in the preferred embodiment the system is used to calculate the emissions of the purchaser's mobile source in a manner similar to step 46. A PEMS is provided and connected to the second mobile source and pollutants from that mobile source are measured to determine the emissions level for the subject pollutant 44. Based on the measured amounts, the system then determines the emissions liability 103, namely the amount of the emissions level 104 over the emissions target 101 for that pollutant and mobile source. Based on this amount, a liability value is assigned to the purchaser 45.

Once a potential purchaser has been identified, the system then identifies available credits 39 and offers or makes those credits available for purchase 40. Based on the program under which the credits are traded, the MERCs can be made available for purchase worldwide or by geographic region. Also, the credits can be offered from a single customer or the system can identify multiple customers who have MERCs available for purchase and can pool such MERCs 40a and make the pooled credits available for purchase. The system then accepts payment from the purchaser 41 for the MERCs. The MERCs are then debited from the customer's account, or from multiple customer accounts if they have been pooled, and transferred to the purchaser 42. The purchase of the MERCs may be in such quantities as to offset all of the assigned liability of the purchaser 42a or may be purchased to offset just a portion of the assigned liability 42b. If the purchaser purchases enough credits to offset all of that purchaser's assigned liability, the system can certify the purchaser as being neutral 42c. The MERCs are offered for purchase at a price to be determined on the open market. Thus, the price of the MERCs fluctuates based on demand.

The present invention contemplates that many changes and modifications may be made. Therefore, while the presently-preferred form of the method and system has been shown and described, and several embodiments discussed, persons skilled in this art will readily appreciate that various additional changes and modifications may be made without departing from the spirit of the invention, as defined and differentiated by the following claims.

What is claimed is:

1. A method for providing a mobile emissions reduction credit or other tradable commodity, comprising the steps of:
identifying an emissions reduction technology for a pollutant;
providing a mobile source;
providing a portable emissions measurement system (PEMS) adapted to measure emissions of said pollutant;
connecting said PEMS to said mobile source;
taking first measurements of said pollutant from said mobile source;
analyzing said measurements to develop a baseline emissions amount;
applying said emissions reduction technology to said mobile source to provide a modified mobile source;
connecting said PEMS to said modified mobile source;
taking second measurements of said modified mobile source;
analyzing said second measurements to develop a modified emissions amount;
quantifying the mobile emissions reduction produced by said emissions reduction technology; and
converting said mobile emissions reduction into a tradable commodity.

2. The method set forth in claim 1, and further comprising the step of marketing said tradable commodity.

3. The method set forth in claim 1, and further comprising the step of monetizing said tradable commodity.

4. The method set forth in claim 1, wherein said tradable commodity is a mobile emissions reduction credit (MERC).

5. The method set forth in claim 4, and further comprising the step of marketing said MERC.

6. The method set forth in claim 4, and further comprising the step of monetizing said MERC.

7. The method set forth in claim 1, wherein said step of converting said mobile emissions reduction into a tradable commodity comprises the step of converting said reduction or a portion of said reduction into at least one tradable credit.

8. The method set forth in claim 7, and further comprising the step of marketing said credit.

9. The method set forth in claim 7, and further comprising the step of monetizing said credit.

10. The method set forth in claim 1, wherein said step of converting said mobile emissions reduction into a tradable commodity comprises the steps of:
receiving information to identify a customer account;
assigning said mobile emissions reduction to said customer account;
calculating a mobile emissions reduction credit (MERC) from said mobile emissions reduction; and
crediting said MERC to said customer account.

11. The method set forth in claim 10, and further comprising the step of exchanging said MERC in said customer account for monetary assets.

12. The method set forth in claim 10, and further comprising the step of debiting said MERC from said customer account.

13. The method set forth in claim 10, and further comprising the steps of:
receiving information to identify a second customer or purchaser account;
calculating an emissions amount of said pollutant for said second account;
assigning a liability value to said emissions amount for said second account.

14. The method set forth in claim 13, and further comprising the steps of:
accepting payment from said second customer;
using said payment to purchase at least one MERC for said second customer;
crediting said MERC as assets against said liability value assigned to said second customer for said emissions amount;
whereby the emissions amount and liability value in said second customer account is reduced accordingly.

15. The method set forth in claim 1, wherein said pollutant is selected from a group consisting of nitrogen oxides (NOₓ), carbon monoxides (CO), carbon dioxides (CO₂), hydrocarbons (HC), sulfur oxides (SOₓ), particulate matter (PM) and volatile organic compounds (VOCs).

16. The method set forth in claim 1, wherein said emissions reduction technology is selected from a group consisting of alternative fuels, vehicle repairs, vehicle replacements, vehicle retrofits and hybrid engines.

17. The method set forth in claim 1, wherein said mobile source is selected from a group consisting of passenger cars, light trucks, large trucks, buses, motorcycles, off-road recreational vehicles, farm equipment, construction equipment, lawn and garden equipment, marine engines, aircraft, locomotives and water vessels.

18. The method set forth in claim 1, wherein said mobile source comprises an exhaust system and said PEMS is connected to said mobile source by a temporarily connection to said exhaust system.

19. The method set forth in claim 1, wherein said mobile source comprises a combustion engine and said PEMS is connected to said engine and is adapted to sense operating parameters of said engine.

20. The method set forth in claim 1, wherein said baseline emissions amount is measured in units translatable into a commoditized weight.

21. The method set forth in claim 20, wherein said units are selected from a group consisting of grams per mile, grams per gallon and grams per brake-horsepower-hour.

22. The method set forth in claim 1, and further comprising the steps of:
taking third measurements of said modified mobile source after taking said second measurements;
analyzing said third measurements to verify said modified emissions amount.

23. The method set forth in claim 1, and further comprising the step of periodically monitoring said modified mobile source with said PEMS to determine if said emissions reduction technology is continuing to provide said modified emissions amount.

24. The method set forth in claim 1, and further comprising the steps of:
providing a computer system;
inputting said baseline emissions amount and said modified emissions amount into said computer system;
processing said amounts to determine a number of mobile emissions reduction credits for said pollutant; and
marketing said mobile emissions reduction credits.

25. A method for providing a mobile emissions reduction credit or other tradable commodity, comprising the steps of:
identifying an emissions reduction technology for a pollutant;
providing a mobile source;
providing a portable emissions measurement system (PEMS) adapted to measure emissions of said pollutant;
applying said emissions reduction technology to said mobile source to provide a modified mobile source;
connecting said PEMS to said modified mobile source;
taking measurements of said modified mobile source;
analyzing said measurements to develop a modified emissions amount;
determining a target emissions amount;
determining the difference between said target emissions amount and said modified emissions amount; and
converting said difference between said target emissions amount and said modified emissions amount into a tradable commodity.

26. The method set forth in claim 25, and further comprising the step of marketing said tradable commodity.

27. The method set forth in claim 25, and further comprising the step of monetizing said tradable commodity.

28. The method set forth in claim 25, wherein said tradable commodity is a mobile emissions reduction credit (MERC).

29. The method set forth in claim 28, and further comprising the step of marketing said MERC.

30. The method set forth in claim 28, and further comprising the step of monetizing said MERC.

31. The method set forth in claim 25, wherein said step of converting said difference between said target emissions amount and said modified emissions amount into a tradable commodity comprises the step of converting said difference into at least one tradable credit.

32. The method set forth in claim 31, and further comprising the step of marketing said credit.

33. The method set forth in claim 31, and further comprising the step of monetizing said credit.

34. The method set forth in claim 25, wherein said step of converting said difference between said target emissions amount and said modified emissions amount into a tradable commodity comprises the steps of:
receiving information to identify a customer account;
assigning said difference to said customer account; and
calculating a mobile emissions reduction credit (MERC) from said difference; and
crediting said MERC to said customer account.

35. The method set forth in claim 34, and further comprising the step of exchanging said MERC in said customer account for monetary assets.

36. The method set forth in claim 34, and further comprising the step of debiting said MERC from said customer account.

37. The method set forth in claim 34, and further comprising the steps of:
receiving information to identify a second customer account;
calculating an emissions amount of said pollutant for said second account;
assigning a liability value to said emissions amount for said second account.

38. The method set forth in claim 37, and further comprising the steps of:
accepting payment from said second customer;
using said payment to purchase at least one MERC for said second customer;
crediting said MERC as assets against said liability value assigned to said second customer for said emissions amount;
whereby the emissions amount and liability value in said second customer account is reduced accordingly.

39. The method set forth in claim 25, wherein said pollutant is selected from a group consisting of nitrogen oxides (NOₓ), carbon monoxides (CO), carbon dioxides (CO₂), hydrocarbons (HC), sulfur oxides (SOₓ), particulate matter (PM) and volatile organic compounds (VOCs).

40. The method set forth in claim 25, wherein said emissions reduction technology is selected from a group consisting of alternative fuels, vehicle repairs, vehicle replacements, vehicle retrofits and hybrid engines.

41. The method set forth in claim 25, wherein said mobile source is selected from a group consisting of passenger cars, light trucks, large trucks, buses, motorcycles, off-road recreational vehicles, farm equipment, construction equipment, lawn and garden equipment, marine engines, aircraft, locomotives and water vessels.

42. The method set forth in claim 25, wherein said mobile source comprises an exhaust system and said PEMS is connected to said mobile source by a temporarily connection to said exhaust system.

43. The method set forth in claim 25, wherein said mobile source comprises a combustion engine and said PEMS is connected to said engine and is adapted to sense operating parameters of said engine.

44. The method set forth in claim 25, wherein said target emissions amount is measured in units translatable into a commoditized weight and said units are selected from a group consisting of grams per mile, grams per gallon and grams per brake-horsepower-hour.

45. The method set forth in claim 25, and further comprising the steps of:
taking third measurements of said modified mobile source after taking said second measurements;
analyzing said third measurements to verify said modified emissions amount.

46. The method set forth in claim 25, and further comprising the step of periodically monitoring said modified mobile source with said PEMS to determine if said emissions reduction technology is continuing to provide said modified emissions amount.

47. The method set forth in claim 25, and further comprising the steps of:
providing a computer system;
inputting said target emissions amount and said modified emissions amount into said computer system;
processing said amounts to determine a number of mobile emissions reduction credits for said pollutant; and
marketing said mobile emissions reduction credits.

48. The method set forth in claim 25, wherein said step of determining a target emissions amount comprises the steps of:
providing a portable emissions measurement system (PEMS) adapted to measure emissions of said pollutant;
connecting said PEMS to said mobile source;
taking first measurements of said pollutant from said mobile source;
analyzing said measurements to develop a baseline emissions amount.

49. The method set forth in claim 25, wherein said target emissions amount is a function of a regulation or standard.

50. A method for providing a mobile emissions reduction credit or other tradable commodity, comprising the steps of:
identifying an emissions reduction technology for a pollutant;
providing a mobile source;
providing a portable emissions measurement system (PEMS) adapted to measure emissions of said pollutant;
applying said emissions reduction technology to said mobile source to provide a modified mobile source;
connecting said PEMS to said modified mobile source;
taking measurements of said modified mobile source;
analyzing said measurements to develop a modified emissions amount;
determining a target emissions amount;
determining the difference between said target emissions amount and said modified emissions amount;
registering for a seller said emissions reduction technology or said pollutant;
assigning to said seller a mobile emissions reduction credit (MERC) that is a function of said difference in said emissions;
making said MERC available for purchase;
receiving a purchase request from a purchaser for said MERC;
matching said seller and purchaser; and
crediting said MERC to an account of said purchaser as an asset.

51. The method set forth in claim 50, wherein said step of making said MERC available for purchase comprises pooling said MERC in a pool with other MERC values from a plurality of sellers having MERC values associated with said technology or said pollutant.

52. The method set forth in claim 50, and further comprising the step of receiving a fee from said purchaser.

53. The method set forth in claim 52, wherein said fee is obtained prior to crediting said MERC to the account of said purchaser.

54. The method set forth in claim 50, and further comprising the step of purchasing an amount of MERC from a seller sufficient to offset a liability value for said pollutant assigned to said purchaser.

55. The method set forth in claim 54, and further comprising the step of certifying said purchaser as being neutral as a result of said offset.

56. The method set forth in claim 50, wherein said pollutant is selected from a group consisting of nitrogen oxides (NOₓ), carbon monoxides (CO), carbon dioxides (CO₂), hydrocarbons (HC), sulfur oxides (SOₓ), particulate matter (PM) and volatile organic compounds (VOCs).

57. The method set forth in claim 50, wherein said emissions reduction technology is selected from a group consisting of alternative fuels, vehicle repairs, vehicle replacements, vehicle retrofits and hybrid engines.

58. The method set forth in claim 50, wherein said mobile source is selected from a group consisting of passenger cars, light trucks, large trucks, buses, motorcycles, off-road recreational vehicles, farm equipment, construction equipment, lawn and garden equipment, marine engines, aircraft, locomotives and water vessels.

59. The method set forth in claim 50, wherein said mobile source comprises an exhaust system and said PEMS is connected to said mobile source by a temporarily connection to said exhaust system.

60. The method set forth in claim 50, wherein said mobile source comprises a combustion engine and said PEMS is connected to said engine and is adapted to sense operating parameters of said engine.

61. The method set forth in claim 50, wherein said baseline emissions amount is measured in units translatable into a commoditized weight.

62. The method set forth in claim 61, wherein said units are selected from a group consisting of grams per mile, grams per gallon and grams per brake-horsepower-hour.

63. The method set forth in claim 50, and further comprising the steps of:
taking third measurements of said modified mobile source after taking said second measurements;
analyzing said third measurements to verify said modified emissions amount.

64. The method set forth in claim 50, and further comprising the step of periodically monitoring said modified mobile source with said PEMS to determine if said emissions reduction technology is continuing to provide said modified emissions amount.

65. The method set forth in claim 60, and further comprising the steps of:
providing a computer system;
inputting said target emissions amount and said modified emissions amount into said computer system;
processing said amounts to determine a number of mobile emissions reduction credits for said pollutant; and
marketing said mobile emissions reduction credits.

66. The method set forth in claim 50, wherein said step of determining a target emissions amount comprises the steps of:
providing a portable emissions measurement system (PEMS) adapted to measure emissions of said pollutant;
connecting said PEMS to said mobile source;
taking first measurements of said pollutant from said mobile source;
analyzing said measurements to develop a baseline emissions amount.
